(19) United States
(12) Patent Application Publication
(10) Pub. No.: US 2007/0024202 A1
(43) Pub. Date: Feb. 1, 2007

(54) Power supply and plasma display including the power supply

(76) Inventor: Il-Woon Lee, Suwon-si (KR)

Correspondence Address: Robert E. Bushnell, Suite 300, 1522 K Street, N.W., Washington, DC, 20005, US

(21) Appl. No.: 11/485,267

(22) Filed: Jul. 13, 2006

(30) Foreign Application Priority Data
Jul. 27, 2005 (KR) 10-2005-0068335

(51) Int. Cl. H05B 37/00

(52) U.S. Cl. 315/160

(57) ABSTRACT

A power supply and a plasma display including the power supply includes: a switch electrically coupled to an input terminal; and a Pulse Width Modulation Integrated Circuit (PWM IC) adapted to control a duty cycle ratio of the switch, and to output a predetermined voltage through an output terminal according to the duty cycle ratio of the switch, the PWM IC including a first terminal coupled to a resistive component adapted to determine a switching frequency of the switch; an output load detector electrically coupled to the output terminal and adapted to detect an output load; and a resistance converter adapted to change a total resistance value of the resistive component electrically coupled to the first terminal of the PWM IC in accordance with the detected output load.

### CLAIM OR PRIORITY

This application makes reference to, incorporates the same herein, and claims all benefits accruing under 35 U.S.C.§119 from an application for POWER SUPPLY APPARATUS AND PLASMA DISPLAY DEVICE INCLUDING THE SAME, earlier filed in the Korean Intellectual Property Office on the 27^{th} of July 2005 and there, duly assigned Serial No. 10-2005-0068335.

### BACKGROUND OF THE INVENTION

1. Field of the Invention

The present invention relates to a power supply, and more particularly it relates to a plasma display including the power supply.

2. Description of the Related Art

Recently, plasma display panels (PDPs) have been highlighted since they are advantageous over other flat panel displays such as Liquid Crystal Displays (LCDs) and Field Emission Displays (FEDs) in regard to their high luminance, high luminous efficiency, and wide viewing angle. The PDP is a flat panel display that uses a plasma generated by a gas discharge to display characters or images. The PDP includes, according to its size, more than several tens to millions of pixels arranged in the form of a matrix. A discharge is generated by a plurality of voltages supplied to electrodes of the PDP to drive the PDP.

The PDP includes a power supply including a power factor correction circuit, a plurality of converters, and a stand-by block in order to supply such a plurality of voltages. The power factor correction circuit performs power factor correction and converts an Alternating Current (AC) voltage to a Direct Current (DC) voltage. The plurality of converters respectively convert the DC voltage output from the power factor correction circuit to a plurality of DC voltages, and the stand-by block generates a stand-by voltage.

The power factor correction circuit, the converter, and the stand-by block respectively include a switch and a Pulse Width Modulator Integrated Circuit (PWM IC) to output a predetermined voltage. The PWM IC generates the predetermined voltage by controlling the switch.

In general, the PWM IC has a fixed switching frequency and a pulse width (turn-on time of the switch) varying in accordance with an output load such that the PWM IC outputs a predetermined output voltage. When the output load is low, substantial operation time of the power supply becomes short. However, a PWM IC having a fixed switch frequency controls the switch using the fixed switching frequency, thereby causing a power loss.

In particular, variations of a screen load ratio of the plasma display are severe, resulting in severe variations of the output load. Accordingly, the power loss increases when controlling the switch using the fixed switching frequency.

### SUMMARY OF THE INVENTION

The present invention has been made in an effort to provide a power supply and a plasma display including the power supply having a reduced power loss.

According to one aspect of the present invention, a power supply is provided including: a switch electrically coupled to an input terminal; and a Pulse Width Modulation Integrated Circuit (PWM IC) adapted to control a duty cycle ratio of the switch, and to output a predetermined voltage through an output terminal according to the duty cycle ratio of the switch, the PWM IC including a first terminal coupled to a resistive component adapted to determine a switching frequency of the switch; an output load detector electrically coupled to the output terminal and adapted to detect an output load; and a resistance converter adapted to change a total resistance value of the resistive component electrically coupled to the first terminal of the PWM IC in accordance with the detected output load.

The total resistance value of the resistive component is preferably changed in accordance with changes of the output load to change the switching frequency. The total resistance value of the resistive component is preferably increased and the switching frequency is reduced upon the output load being lower than a predetermined value.

The PWM IC preferably includes a second terminal electrically coupled to a capacitive component adapted to determine the switching frequency, and the switching frequency is preferably determined by the total resistance value of the resistive component and a total capacitance value of the capacitive component electrically coupled to the second terminal.

The output load detector is preferably adapted to output a first voltage proportional to the detected output load, and the resistance converter preferably includes: a comparator adapted to compare a first voltage input to a non-inverting terminal of the comparator to a reference voltage input to an inverting terminal of the comparator; a first resistor having a first terminal coupled to the first terminal of the PWM IC; and a transistor adapted to switch a connection of a second terminal to ground in accordance with an output of the comparator.

The power supply preferably further includes a second resistor connected between the first terminal and ground, and a total resistance value is preferably determined by the second resistor and an equivalent resistance value from the first terminal of the PWM IC to the resistance converter.

According to another aspect of the present invention, a plasma display is provided including: a Plasma Display Panel (PDP) having a plurality of column electrodes and a plurality of row electrodes, a driver adapted to supply a driving signal to the column and row electrodes, and a power source adapted to supply power to the driver, the power source including: a switch electrically coupled to an input terminal; a Pulse Width Modulation Integrated Circuit (PWM IC) having first and second terminals, and adapted to control a duty cycle ratio of the switch, the first terminal being coupled to a resistive component adapted to determine a switching frequency of the switch, and the second terminal being coupled to a capacitive component adapted to determine the switching frequency of the switch; an output load detector electrically coupled to an output terminal and adapted to detect an output load; and a resistance converter adapted to change a total resistance value of the resistive component electrically coupled to the first terminal of the PWM IC in accordance with the detected output load.

The total resistance value of the resistive component is preferably increased and the switching frequency is preferably reduced upon the output load being decreased. The total resistance value of the resistive component is preferably increased and the switching frequency is preferably reduced upon the output load being lower than a predetermined value.

The output load preferably corresponds to a screen load ratio of the PDP.

The output load detector is preferably adapted to output a first voltage corresponding to the detected output load, and the resistance converter preferably includes: a comparator adapted to compare the first voltage input to a non-inverting terminal of the comparator to a reference voltage input to an inverting terminal of the comparator; a first resistor having a first terminal coupled to the first terminal of the PWM IC; and a transistor adapted to switch a connection of the second terminal to ground in accordance with an output of the comparator.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a plasma display according to an exemplary embodiment of the present invention.

FIG. 2 is a block diagram of a power source according to an exemplary embodiment of the present invention.

FIG. 3 is a block diagram of a Direct Current (DC)-Direct Current (DC) converter included in a voltage generator according to an exemplary embodiment of the present invention.

FIG. 4 is a block diagram of the Pulse Width Modulation Integrated Circuit (PWM IC) of FIG. 3 and its peripheral configuration.

FIG. 5 is a circuit diagram of the resistance converter of FIG. 3.

### DETAILED DESCRIPTION OF THE INVENTION

In the following detailed description, only certain exemplary embodiments of the present invention have been shown and described, simply by way of illustration. As those skilled in the art would realize, the described embodiments can be modified in various different ways, all without departing from the spirit or scope of the present invention.

Accordingly, the drawings and description are to be regarded as illustrative in nature and not restrictive. Like reference numerals designate like elements throughout the specification.

A plasma display and a plasma display including the power supply are described below with reference to the accompanying drawings.

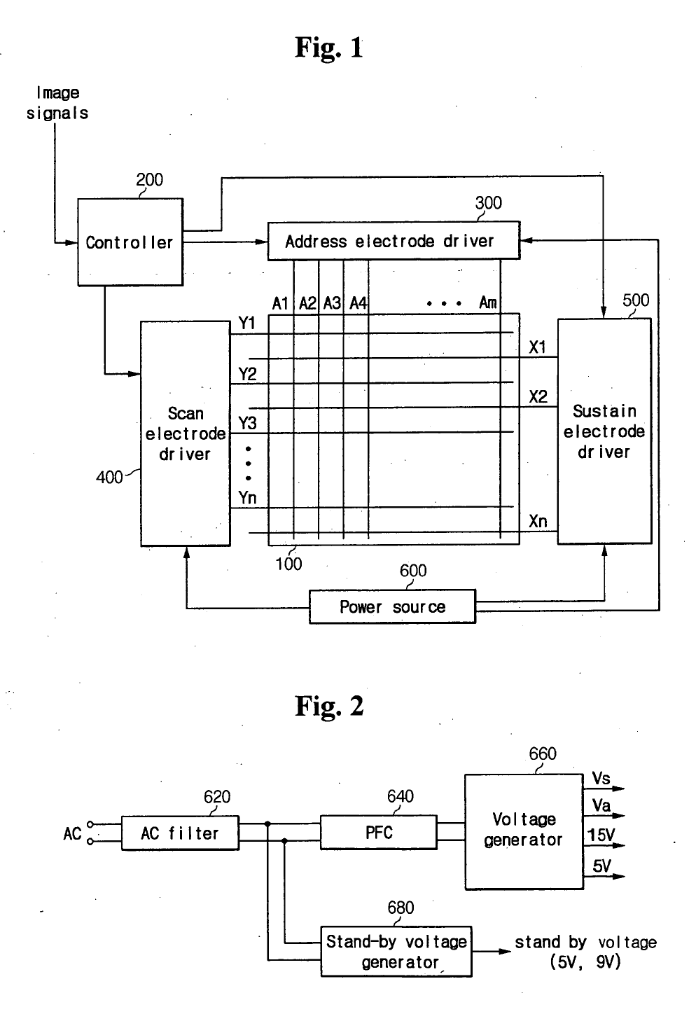

FIG. 1 is a block diagram of a plasma display according to an exemplary embodiment of the present invention.

As shown in FIG. 1, the plasma display includes a Plasma Display Panel (PDP) 100, a controller 200, an address driver 300, a scan electrode driver 400, a sustain electrode driver 500, and a power source 600.

The PDP 100 has a plurality of address electrodes A1-Am elongated in a column direction and a plurality of sustain electrodes X1-Xn elongated in a row direction, in pairs. Generally, the sustain electrodes X1-Xn are formed in correspondence to the respective scan electrodes Y1-Yn, and respective ends thereof are coupled to each other. In addition, the PDP 100 includes a substrate in which the sustain and scan electrodes X1-Xn and Y1-Yn are arranged (not shown), and another substrate in which the address electrodes A1-Am are arranged (not shown).

The two substrates are arranged to face each other with a discharge space therebetween so that the scan electrodes Y1-Yn and the address electrodes A1-Am perpendicularly cross each other and the sustain electrodes X1-Xn and the address electrodes A1-Am perpendicularly cross each other. The discharge space formed at a crossing region of the address electrodes A1-Am and the sustain and scan electrodes X1-Xn and Y1-Yn forms a discharge cell. This is an exemplary structure of the PDP 100, and panels having other structures can be applied to the present invention.

The controller 200 receives an external video signal and outputs an address electrode driving control signal, a sustain electrode driving control signal, and a scan electrode driving control signal. In addition, the controller 200 controls the plasma display by dividing a frame into a plurality of subfields having respective brightness weight values. Each subfield can be expressed as operational changes according to time, which include a reset period, an address period, and a sustain period.

The address electrode driver 300 receives the address electrode driving control signal from the controller 200 and supplies a display data signal to the respective address electrodes A1-Am for selecting discharge cells to br turned-on.

The scan electrode driver 400 receives the scan electrode driving control signal from the controller 200 and supplies a driving voltage to the respective scan electrodes Y1-Yn.

The sustain electrode driver 500 receives the sustain electrode driving control signal from the controller 200 and supplies a driving voltage to the respective sustain electrodes X1-Xn.

The power source 600 generates a plurality of voltages used for the plasma display and supplies the voltages to the respective drivers 300, 400, and 500. The respective drivers 300, 400, and 500 supply the voltages supplied from the power source 600 to the respective electrodes (address, sustain, and scan electrodes) of the PDP 100 for driving the PDP 100.

FIG. 2 is a block diagram of a power source according to an exemplary embodiment of the present invention.

As shown in FIG. 2, the power source 600 includes an Alternating Current (AC) filter 620, a Power Factor Correction (PFC) circuit 640, a voltage generator 660, and a stand-by voltage generator 680.

The AC filter 620 filters an externally input AC voltage to eliminate noise. The PFC 640 receives the AC voltage output from the AC filter, corrects a power factor, and outputs a Direct Current (DC) voltage. The voltage generator 660, including a plurality of DC-DC converters, receives the DC voltage output from the PFC 640, generates a plurality of DC voltages Vs, Va, 15V, and 5V for the plasma display, and supplies the DC voltages to the respective drivers 300, 400, and 500. In addition, the stand-by voltage generator 680 receives the AC voltage output from the AC filter 620, and generates and outputs stand-by voltages of 5V and 9V.

The PFC 640, the voltage generator 660, and the stand-by voltage generator 680 respectively include a switch and a Pulse Width Modulator Integrated Circuit (PWM IC) to generate a predetermined voltage. The PWM IC according to an exemplary embodiment of the present invention has an arbitrary switching frequency that varies depending on an output load rather than having a fixed switching frequency, and accordingly power losses can be reduced. The output load in the following description corresponds to a screen load ratio of the plasma display.

Since the amount of power consumption of the plasma display significantly varies depending on the screen load ratio, the output load of the power source 600 corresponds to the screen load ratio of the plasma display. That is, the output load increases when the screen load ratio of the plasma display is high, whereas the output load decreases when the screen load ratio of the plasma display is low.

For better comprehension and ease of description, one of the plurality of DC-DC converters included in the voltage generator 660 is exemplarily described below, and this exemplary DC-DC converter can also be applied to the PFC 640 and the stand-by voltage generator 680.

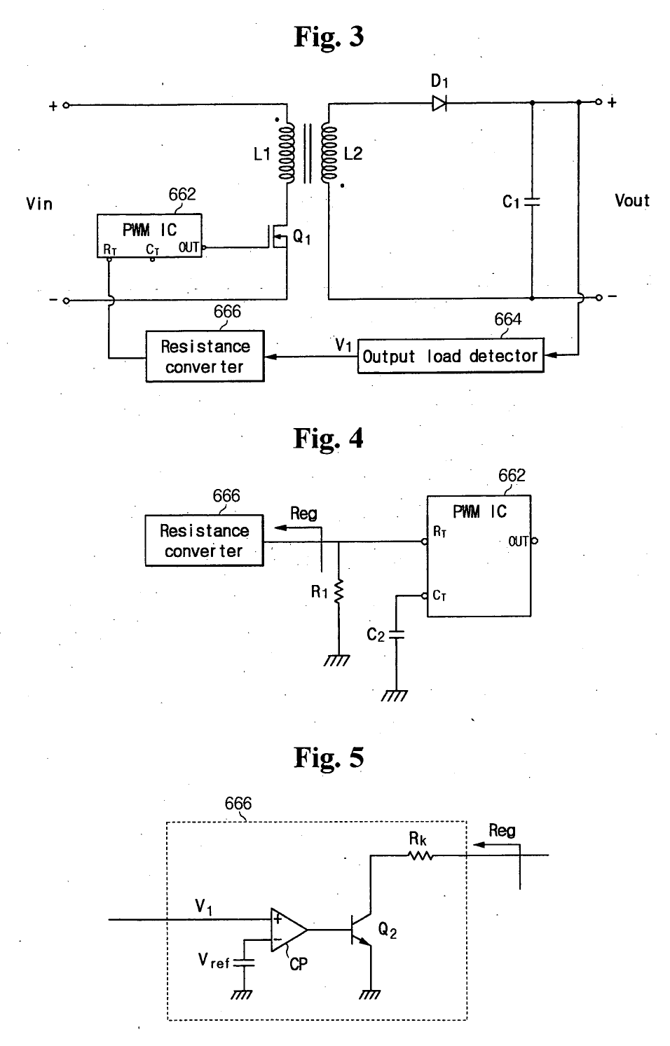

FIG. 3 is a block diagram of a DC-DC converter included in a voltage generator according to an exemplary embodiment of the present invention, FIG. 4 is a block diagram of the Pulse Width Modulation Integrated Circuit (PWM IC) of FIG. 3 and its peripheral configuration, and FIG. 5 is a circuit diagram of the resistance converter of FIG. 3.

As shown in FIG. 3, the DC-DC converter includes transformer coils L1 and L2, a switch Q1, a diode D1, a capacitor C1, a PWM IC 662, an output load detector 664, and a resistance converter 666. The DC-DC converter of FIG. 3 receives a DC voltage Vin and outputs a predetermined DC voltage Vout to two terminals of the capacitor C1 by controlling the duty cycle ratio of the switch Q1.

A first end of a first coil L1 of the transformer is coupled to an input terminal of the DC-DC converter, and a drain, a source, and a gate of the switch Q1 are coupled to a second end of the first coil L1, ground, and an output terminal OUT of the PWM IC 662, respectively. In addition, a first end of a second coil L2 of the transformer is coupled to an anode of the diode D1, and the capacitor C1 is coupled between a cathode of the diode D1 and a second end of the second coil L2 of the transformer.

The switch Q1 of FIG. 3 is a MOSFET, but can be replaced by a bipolar transistor or other switching element.

The PWM IC 662 outputs a signal that controls the turn-on/turn-off of the switch Q1 through the output terminal OUT, and a predetermined output voltage Vout is output to two terminals of the capacitor C1 in accordance with the turn-on/turn-off of the switch Q1. The PWM IC 662 includes terminals RT and CT that determine a switching frequency f, and a resistor Rt having a predetermined resistance value is coupled to the terminal RT and a capacitor Ct having a predetermined capacitance value is coupled to the terminal CT.

A typical PWM IC includes the two terminals RT and CT, and the switching frequency f of the switch Q1 is determined by the resistor Rt and the capacitor Ct coupled to the terminals RT and CT, respectively. Both a commercially available TL494 and a UC3825/3824 PWM IC can be used as the PWM IC, and the TL494 and UC3825/3824 also include two terminals that determine a switching frequency. The switching frequency f determined by the resistor Rt coupled to the terminal RT and the capacitor Ct coupled to the terminal CT is derived from Equation 1 below.

$$Equation 1 \text{:}$$

$$f = \frac{1.25}{\sqrt{{R}_{t} ⨯ {C}_{t}}} Hz$$

wherein f denotes a switching frequency determined by the PWM IC 662, Rt denotes a total resistance value at the terminal RT, and Ct denotes a total capacitance value at the terminal CT.

Referring to FIG. 4, a resistor R1 and a resistance converter 666 are coupled to the terminal RT of the PWM IC 662, and a capacitor C2 is coupled to the terminal CT of the PWM IC 662. In FIG. 4, Req denotes an equivalent resistance value flowing from the resistance converter 666 to the terminal RT. Accordingly, a total resistance value of the resistor Rt at the terminal CT becomes Req//R1(=(Req*R1)/(Req+R1)).

The PWM IC 662 according to the exemplary embodiment of the present invention changes the total resistance values of the resistor Rt at the terminal RT in accordance with the output load such that the switching frequency f is changed accordingly. This is described in more detail in the following description.

The output load detector 664 is coupled to an output terminal, that is, the cathode of the diode D1, to detect an output load of the DC-DC converter, and receives a value corresponding to an output current. In addition, the output load detector 664 generates a voltage V1 corresponding to the output current and outputs the voltage V1. Since the output current increases when the output load is high, the voltage V1 output from the output load detector 664 increases when the output load is high.

The output load detector 664 uses a hole sensor, a current transformer, or a sensing resistor to detect an output current (i.e., the corresponding value of an output load), and to generate a voltage V1 corresponding to the output current can be as simple as coupling a resistor. This method is well-known to a person of an ordinary skill in the art, and therefore, a further description has not been provided.

The resistance converter 666 receives the voltage V1 output from the output load detector 664, and outputs a resistance Req corresponding to the voltage V1 through an output terminal of the resistance converter 666. That is, the resistance converter 666 outputs a higher resistance Req when the voltage V1 is low rather than high.

Referring to FIG. 5, the resistance converter 666 includes a comparator CP, a transistor Q2, and a resistor Rk. A reference voltage Vref is input to an inverting terminal (i.e., a negative (−) terminal) of the comparator CP and the voltage V1 output from the output load detector 664 is input to a non-inverting terminal (i.e., a positive (+) terminal) of the comparator CP. A base of the transistor Q2 is coupled to an output terminal of the comparator CP and an emitter of the transistor Q2 is coupled to a ground of the comparator CP. The resistor Rk is coupled between a collector of the transistor Q2 and the terminal RT of the PWM IC 662. When a PWM IC 662 performs switching using the fixed switching frequency, the reference voltage Vref is set to correspond to the output load that causes the power loss. Such a reference voltage Vref can be experimentally obtained.

When the voltage V1 output from the output load detector 664 is higher than the reference voltage Vref (i.e., when the output load is higher than a predetermined value), the comparator CP outputs a high-level signal, and accordingly, the transistor Q2 is turned on. Therefore, the equivalent resistance Req corresponds to the resistance value of the resistor Rk.

In addition, when the voltage V1 output from the output load detector 664 is lower than the reference voltage Vref (i.e., when the output load is lower than the predetermined value), the comparator CP outputs a low signal, and accordingly, the transistor Q2 is turned off. When the transistor Q2 is turned off, the equivalent resistance Req becomes infinite.

FIG. 5 is an example of one method of generating the equivalent resistance Req in accordance with the voltage V1 output from the resistance converter 666, and other methods can also be used according to other embodiments of the present invention.

A method of changing a switching frequency of the PWM IC 662 in accordance with an output load in the DC-DC converter with the above described configuration is described below.

The switching frequency f of the PWM IC 662 is described as follows for the case in which the output load is higher than the predetermined value. Since the amount of output current increases when the output load is high, the output load detector 664 outputs a high-level voltage V1. When the voltage V1 is higher than the reference voltage Vref input to the negative (−) terminal of the comparator CP, the comparator CP outputs a high signal, and accordingly, the transistor Q2 is turned on and the equivalent resistance Req corresponds to the resistance value of the resistor Rk.

Therefore, a total resistance value of the resistor Rt coupled to the terminal RT of the PWM IC 662 becomes R1//Rk, and the switching frequency f of the PWM IC 662 becomes (1.25 Hz)/((R1//Rk)*C2)½ by Equation 1.

The switching frequency f of the PWM IC 662 is described as follows for the case in which the output load is lower than the predetermined value. Since the amount of output current decreases when the output load is low, the output load detector 664 outputs a low-level voltage V1. When the voltage V1 is lower than the reference voltage Vref, the comparator CP outputs a low signal, and accordingly, the transistor Q2 is turned off and the equivalent resistance Req becomes infinite (∞).

Therefore, the total resistance value of the resistor Rt of the PWM IC 662 corresponds to the resistance value of the resistor R1, and the switching frequency f of the PWM IC 662 becomes (1.25 Hz)/(R1*C2)½ by Equation 1. That is, the switching frequency f decreases when the output is low rather than high.

As described, when the output load is lower than the predetermined value, non-operation time of the DC-DC converter is increased by reducing the switching frequency to thereby reduce the power loss. That is, the power loss was unavoidable when a PWM IC having the fixed switching frequency was used. However, the switching frequency can be reduced when the output load is lower than the predetermined value so that unwanted power loss can be avoided according to the embodiment of the present invention.

In particular, power loss of the plasma display having severe output load variations can be reduced by controlling the switching frequency in accordance of the output load.

On the other hand, the method of controlling the switching frequency of the PWM IC 662 used for the DC-DC converter in accordance with the output load of the DC-DC converter can also be respectively applied to PWM ICs used for the PFC 640 and the stand-by voltage generator 680.

As described, the unwanted power loss can be reduced by changing the switching frequency in accordance with the output load according to the exemplary embodiment of the present invention.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A power supply, comprising:
a switch electrically coupled to an input terminal; and
a Pulse Width Modulation Integrated Circuit (PWM IC) adapted to control a duty cycle ratio of the switch, and to output a predetermined voltage through an output terminal according to the duty cycle ratio of the switch, the PWM IC including a first terminal coupled to a resistive component adapted to determine a switching frequency of the switch;
an output load detector electrically coupled to the output terminal and adapted to detect an output load; and
a resistance converter adapted to change a total resistance value of the resistive component electrically coupled to the first terminal of the PWM IC in accordance with the detected output load.

2. The power supply of claim 1, wherein the total resistance value of the resistive component is changed in accordance with changes of the output load to change the switching frequency.

3. The power supply of claim 1, wherein the total resistance value of the resistive component is increased and the switching frequency is reduced upon the output load being lower than a predetermined value.

4. The power supply of claim 2, wherein the total resistance value of the resistive component is increased and the switching frequency is reduced upon the output load being lower than a predetermined value.

5. The power supply of claim 1, wherein the PWM IC comprises a second terminal electrically coupled to a capacitive component adapted to determine the switching frequency, and wherein the switching frequency is determined by the total resistance value of the resistive component and a total capacitance value of the capacitive component electrically coupled to the second terminal.

6. The power supply of claim 5, wherein the output load detector is adapted to output a first voltage proportional to the detected output load, and wherein the resistance converter comprises:
a comparator adapted to compare a first voltage input to a non-inverting terminal of the comparator to a reference voltage input to an inverting terminal of the comparator;
a first resistor having a first terminal coupled to the first terminal of the PWM IC; and
a transistor adapted to switch a connection of a second terminal to ground in accordance with an output of the comparator.

7. The power supply of claim 6, further comprising a second resistor connected between the first terminal and ground, wherein a total resistance value is determined by the second resistor and an equivalent resistance value from the first terminal of the PWM IC to the resistance converter.

8. A plasma display, comprising:
a Plasma Display Panel (PDP) having a plurality of column electrodes and a plurality of row electrodes,
a driver adapted to supply a driving signal to the column and row electrodes, and
a power source adapted to supply power to the driver, the power source including:
a switch electrically coupled to an input terminal;
a Pulse Width Modulation Integrated Circuit (PWM IC) having first and second terminals, and adapted to control a duty cycle ratio of the switch, the first terminal being coupled to a resistive component adapted to determine a switching frequency of the switch, and the second terminal being coupled to a capacitive component adapted to determine the switching frequency of the switch;
an output load detector electrically coupled to an output terminal and adapted to detect an output load; and
a resistance converter adapted to change a total resistance value of the resistive component electrically coupled to the first terminal of the PWM IC in accordance with the detected output load.

9. The plasma display of claim 8, wherein the total resistance value of the resistive component is increased and the switching frequency is reduced upon the output load being decreased.

10. The plasma display of claim 8, wherein the total resistance value of the resistive component is increased and the switching frequency is reduced upon the output load being lower than a predetermined value.

11. The plasma display of claim 8, wherein the output load corresponds to a screen load ratio of the PDP.

12. The plasma display of claim 8, wherein the output load detector is adapted to output a first voltage corresponding to the detected output load, and wherein the resistance converter comprises:
a comparator adapted to compare the first voltage input to a non-inverting terminal of the comparator to a reference voltage input to an inverting terminal of the comparator;
a first resistor having a first terminal coupled to the first terminal of the PWM IC; and
a transistor adapted to switch a connection of the second terminal to ground in accordance with an output of the comparator.
